(19) United States
(12) Patent Application Publication
(10) Pub. No.: US 2026/0197736 A1
(43) Pub. Date: Jul. 9, 2026

(54) Method and Apparatus for Group Handover Configuration in Non-Terrestrial Network

(71) Applicants: HYUNDAI MOTOR COMPANY, Seoul (KR); KIA CORPORATION, Seoul (KR); INHA UNIVERSITY RESEARCH AND BUSINESS FOUNDATION, Incheon (KR)

(72) Inventors: Young Kil SUH, Hwaseong-si, Gyeonggi-do (KR); Jeong Su LEE, Hwaseong-si, Gyeonggi-do (KR); Ui Hyun HONG, Hwaseong-si, Gyeonggi-do (KR); Gene Back HAHN, Hwaseong-si, Gyeonggi-do (KR); Dong Kyu KIM, Hwaseong-si, Gyeonggi-do (KR); Duk Kyung KIM, Seoul (KR)

(73) Assignees: HYUNDAI MOTOR COMPANY, Seoul (KR); KIA CORPORATION, Seoul (KR); INHA UNIVERSITY RESEARCH AND BUSINESS FOUNDATION, Incheon (KR)

(21) Appl. No.: 19/131,295

(22) PCT Filed: Feb. 16, 2024
(86) PCT No.: PCT/KR2024/095303

§ 371 Date: May 20, 2025

(30) Foreign Application Priority Data
Feb. 17, 2023 (KR) 10-2023-0021384
Jul. 28, 2023 (KR) 10-2023-0099068

(51) Int. Cl. H04W 36/08; H04W 36/00

(52) U.S. Cl. CPC H04W 36/083; H04W 36/0085

(57) ABSTRACT

Disclosed are a method and apparatus for a group handover configuration in a non-terrestrial network. The method for a user equipment (UE) may comprise the steps of: on the basis of a beam spot supported by a satellite, receiving, from the satellite, group configuration information regarding a group comprising the UE; receiving, from the satellite, a group indicator indicating the group; measuring channel state information (CSI) regarding the group; reporting a message comprising the CSI to the satellite; and receiving, from the satellite, a handover command message for a handover determined on the basis of the result of the measurement of the CISI.

### TECHNICAL FIELD

The present disclosure relates to a group handover technique in a non-terrestrial network, and more particularly, to a technique for configuring groups for a group handover.

### BACKGROUND ART

A communication network (e.g. 5G communication network, 6G communication network, etc.) to provide enhanced communication services compared to the existing communication network (e.g. long term evolution (LTE), LTE-Advanced (LTA-A), etc.) is being developed. The 5G communication network (e.g. new radio (NR) communication network) can support not only a frequency band of 6 GHz or below, but also a frequency band of 6 GHz or above. That is, the 5G communication network can support a frequency range (FR1) band and/or FR2 band. The 5G communication network can support various communication services and scenarios compared to the LTE communication network. For example, usage scenarios of the 5G communication network may include enhanced Mobile BroadBand (eMBB), Ultra Reliable Low Latency Communication (URLLC), Massive Machine Type Communication (mMTC), and the like.

The 6G communication network can support a variety of communication services and scenarios compared to the 5G communication network. The 6G communication networks can meet the requirements of hyper-performance, hyper-bandwidth, hyper-space, hyper-precision, hyper-intelligence, and/or hyper-reliability. The 6G communication networks can support various and wide frequency bands and can be applied to various usage scenarios (e.g. terrestrial communication, non-terrestrial communication, sidelink communication, and the like).

The communication network (e.g. 5G communication network, 6G communication network, etc.) may provide communication services to terminals located on the ground. Recently, the demand for communication services for not only terrestrial but also non-terrestrial airplanes, drones, and satellites has been increasing, and for this purpose, technologies for a non-terrestrial network (NTN) have been discussed. The non-terrestrial network may be implemented based on 5G communication technology, 6G communication technology, and/or the like. For example, in the non-terrestrial network, communication between a satellite and a terrestrial communication node or a non-terrestrial communication node (e.g. airplane, drone, or the like) may be performed based on 5G communication technology, 6G communication technology, and/or the like. In the NTN, the satellite may perform functions of a base station in a communication network (e.g. 5G communication network, 6G communication network, and/or the like).

Meanwhile, in a terrestrial network (TN), handovers may occur based on individual movements of terminals. As a result, handover request messages may be transmitted to a satellite in a distributed manner according to the movements of the respective terminals. Therefore, when handover procedures are performed simultaneously by multiple terminals, the handover procedures may not be successfully performed. When a base station processes multiple handovers simultaneously, procedures such as signal strength measurement and reporting at the terminals, handover requests and responses, and handover commands may be performed concurrently, resulting in increased signaling overhead.

On the other hand, in a non-terrestrial network (NTN), handovers may occur due to movement of a satellite. In this case, handovers may occur simultaneously for multiple terminals due to the movement of the satellite. In addition, frequent handovers may occur due to a high speed of the satellite. Accordingly, in a non-terrestrial network, the satellite and/or base station may experience a high load while processing the simultaneously occurring handovers. Therefore, the present disclosure proposes methods of processing handovers based on groups in order to reduce the load that occurs during the processing of a large number of handovers in the NTN environment.

### DISCLOSURE

### Technical Problem

The present disclosure is directed to providing a method and an apparatus for group handover configuration in a non-terrestrial network.

### Technical Solution

A method of a user equipment (UE), according to a first exemplary embodiment of the present disclosure for achieving the above-described objective, may comprise: receiving, from a satellite, group configuration information for a group including the UE based on a beam area supported by the satellite; receiving, from the satellite, a group indicator indicating the group; measuring channel state information (CSI) for the group; reporting a message including the CSI to the satellite; and receiving, from the satellite, a handover command message for a handover determined based on a result of measuring the CSI.

The group configuration information may include at least one group identifier (ID) based on the beam area.

When a cell remaining time, which is a time during which the UE is in a condition to be serviced by the beam area, falls within a time range configured by the satellite, the group configuration information may include a group ID for identifying the group including UEs having the cell remaining time.

The method may further comprise: determining the beam area that occupies a largest portion of a tracking area among beam areas supported by the satellite as a beam area associated with the tracking area.

The method may further comprise: determining the beam area supporting the UE based on beam area determination information including at least one of location information of the UE, ephemeris information of the satellite, or information of a target base station.

The method may further comprise: receiving, from the satellite, at least one of an indicator instructing to perform a CSI measurement processor and a CSI reporting procedure or an indicator instructing not to perform a CSI measurement procedure and a CSI reporting procedure.

The receiving of the handover command message from the satellite may comprise: receiving, from the satellite, information that the satellite commonly transmits to the group through a unicast, groupcast, or broadcast scheme.

A method of a satellite, according to a second exemplary embodiment of the present disclosure for achieving the above-described objective, may comprise: configuring a group for user equipments (UEs) served by the satellite based on a beam area supported by the satellite; transmitting a group indicator for the group to the UEs; selecting, from among the UEs, at least one UE to perform a channel state information (CSI) measurement procedure and a CSI reporting procedure; receiving a message including CSI for the group from the at least one UE; transmitting a handover request message for a handover determined based on the CSI to a target satellite; receiving a handover request acknowledgement message from the target satellite indicating that a handover request according to the handover request message has been approved; and in response to the handover request of the satellite having been approved by the target satellite, transmitting a handover command message to the UEs belonging to the group.

The configuring of the group for UEs served by the satellite may comprise: configuring the group for the UEs based on at least one of the beam area, cell remaining times which are times during which the UEs are in a condition to be serviced by the beam area, or beam area determination information, wherein the beam area determination information may include at least one of location information of the UEs, ephemeris information of the satellite, or information of the target satellite.

The selecting of the at least one UE to perform the CSI measurement procedure and the CSI reporting procedure may comprise: selecting, from among the UEs, a UE having a cell remaining time falling within a time range configured by the satellite as the at least one UE to perform the CSI measurement procedure and the CSI reporting procedure, the cell remaining time being a time during which the UE is in a condition to be served by the beam area.

The transmitting of the handover command message to the UEs belonging to the group may comprise: transmitting, to the UEs, information to be transmitted commonly to the group through a unicast, groupcast, or broadcast scheme.

A user equipment (UE), according to a third exemplary embodiment of the present disclosure for achieving the above-described objective, may comprise: at least one processor, wherein the at least one processor may cause the UE to perform: receiving, from a satellite, group configuration information for a group including the UE based on a beam area supported by the satellite; receiving, from the satellite, a group indicator indicating the group; measuring channel state information (CSI) for the group; reporting a message including the CSI to the satellite; and receiving, from the satellite, a handover command message for a handover determined based on a result of measuring the CSI.

The group configuration information may include at least one group identifier (ID) based on the beam area.

When a cell remaining time, which is a time during which the UE is in a condition to be serviced by the beam area, falls within a time range configured by the satellite, the group configuration information may include a group ID for identifying the group including UEs having the cell remaining time.

The at least one processor may cause the UE to perform: determining the beam area that occupies a largest portion of a tracking area among beam areas supported by the satellite as a beam area associated with the tracking area.

The at least one processor may cause the UE to perform: determining the beam area supporting the UE based on beam area determination information including at least one of location information of the UE, ephemeris information of the satellite, or information of a target base station.

The at least one processor may cause the UE to perform: receiving, from the satellite, at least one of an indicator instructing to perform a CSI measurement processor and a CSI reporting procedure or an indicator instructing not to perform a CSI measurement procedure and a CSI reporting procedure.

In the receiving of the handover command message from the satellite, the at least one processor may cause the UE to perform: receiving, from the satellite, information that the satellite commonly transmits to the group through a unicast, groupcast, or broadcast scheme.

### Advantageous Effects

According to the present disclosure, in a non-terrestrial network, the satellite can configure terminals into groups. Some terminals within a group may transmit CSI to a base station based on a group indicator. According to the above-described operation, in the non-terrestrial network, the group handover can reduce a load that occurs during the handover processing, and the group handover can also reduce the load related to CSI measurement and reporting procedures of terminals configured as a group.

### DESCRIPTION OF DRAWINGS

FIG. 1A is a conceptual diagram illustrating a first exemplary embodiment of a non-terrestrial network.

FIG. 1B is a conceptual diagram illustrating a second exemplary embodiment of a non-terrestrial network.

FIG. 2A is a conceptual diagram illustrating a third exemplary embodiment of a non-terrestrial network.

FIG. 2B is a conceptual diagram illustrating a fourth exemplary embodiment of a non-terrestrial network.

FIG. 2C is a conceptual diagram illustrating a fifth exemplary embodiment of a non-terrestrial network.

FIG. 3 is a block diagram illustrating a first exemplary embodiment of a communication node constituting a non-terrestrial network.

FIG. 4 is a block diagram illustrating a first exemplary embodiment of communication nodes performing communication.

FIG. 5A is a block diagram illustrating a first exemplary embodiment of a transmission path.

FIG. 5B is a block diagram illustrating a first exemplary embodiment of a reception path.

FIG. 6A is a conceptual diagram illustrating a first exemplary embodiment of a protocol stack of a user plane in a transparent payload-based non-terrestrial network.

FIG. 6B is a conceptual diagram illustrating a first exemplary embodiment of a protocol stack of a control plane in a transparent payload-based non-terrestrial network.

FIG. 7A is a conceptual diagram illustrating a first exemplary embodiment of a protocol stack of a user plane in a regenerative payload-based non-terrestrial network.

FIG. 7B is a conceptual diagram illustrating a first exemplary embodiment of a protocol stack of a control plane in a regenerative payload-based non-terrestrial network.

FIG. 8 is a conceptual diagram for describing EFB.

FIG. 9 is a conceptual diagram for describing EMB.

FIG. 10A is a conceptual diagram illustrating a first exemplary embodiment of a handover procedure.

FIG. 10B is a conceptual diagram illustrating a second exemplary embodiment of a handover procedure.

FIG. 11 is a conceptual diagram illustrating a third exemplary embodiment of a handover procedure.

FIG. 12 is a sequence chart illustrating a first exemplary embodiment of a handover procedure.

FIG. 13 is a sequence chart illustrating a second exemplary embodiment of a handover procedure.

FIG. 14 is a conceptual diagram illustrating a first exemplary embodiment of tracking areas.

FIG. 15 is a conceptual diagram illustrating a first exemplary embodiment of a beam area determination method.

### BEST MODE OF THE INVENTION

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

In the present disclosure, “(re)transmission” may refer to “transmission”, “retransmission”, or “transmission and retransmission”, “(re)configuration” may refer to “configuration”, “reconfiguration”, or “configuration and reconfiguration”, “(re)connection” may refer to “connection”, “reconnection”, or “connection and reconnection”, and “(re)access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the present disclosure. As used herein, the singular forms are intended to include the plural forms as well, unless the context clearly indicates otherwise. It will be further understood that the terms “comprise” and/or “include” when used herein, specify the presence of stated features, integers, steps, operations, elements, components or combinations thereof, but do not preclude the presence or addition of one or more other features, integers, steps, operations, elements, components, and/or combinations thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted. In addition to the exemplary embodiments explicitly described in the present disclosure, operations may be performed according to a combination of the exemplary embodiments, extensions of the exemplary embodiments, and/or modifications of the exemplary embodiments. Performance of some operations may be omitted, and the order of performance of operations may be changed.

Even when a method (e.g. transmission or reception of a signal) performed at a first communication node among communication nodes is described, a corresponding second communication node may perform a method (e.g. reception or transmission of the signal) corresponding to the method performed at the first communication node. That is, when an operation of a user equipment (UE) is described, a base station corresponding to the UE may perform an operation corresponding to the operation of the UE. Conversely, when an operation of a base station is described, a UE corresponding to the base station may perform an operation corresponding to the operation of the base station. In a non-terrestrial network (NTN) (e.g. payload-based NTN), operations of a base station may refer to operations of a satellite, and operations of a satellite may refer to operations of a base station.

The base station may refer to a NodeB, evolved NodeB (eNodeB), next generation node B (gNodeB), gNB, device, apparatus, node, communication node, base transceiver station (BTS), radio remote head (RRH), transmission reception point (TRP), radio unit (RU), road side unit (RSU), radio transceiver, access point, access node, and/or the like. The UE may refer to a terminal, device, apparatus, node, communication node, end node, access terminal, mobile terminal, station, subscriber station, mobile station, portable subscriber station, on-broad unit (OBU), and/or the like.

In the present disclosure, signaling may be at least one of higher layer signaling, medium access control (MAC) signaling, or physical (PHY) signaling. Messages used for higher layer signaling may be referred to as ‘higher layer messages’ or ‘higher layer signaling messages’. Messages used for MAC signaling may be referred to as ‘MAC messages’ or ‘MAC signaling messages’. Messages used for PHY signaling may be referred to as ‘PHY messages’ or ‘PHY signaling messages’. The higher layer signaling may refer to a transmission and reception operation of system information (e.g. master information block (MIB), system information block (SIB)) and/or RRC messages. The MAC signaling may refer to a transmission and reception operation of a MAC control element (CE). The PHY signaling may refer to a transmission and reception operation of control information (e.g. downlink control information (DCI), uplink control information (UCI), and sidelink control information (SCI)).

In the present disclosure, “an operation (e.g. transmission operation) is configured” may mean that “configuration information (e.g. information element(s) or parameter(s)) for the operation and/or information indicating to perform the operation is signaled”. “Information element(s) (e.g. parameter(s)) are configured” may mean that “corresponding information element(s) are signaled”. In the present disclosure, “signal and/or channel” may mean a signal, a channel, or “signal and channel,” and “signal” may be used to mean “signal and/or channel”.

A communication system may include at least one of a terrestrial network, non-terrestrial network, 4G communication network (e.g. long-term evolution (LTE) communication network), 5G communication network (e.g. new radio (NR) communication network), or 6G communication network. Each of the 4G communications network, 5G communications network, and 6G communications network may include a terrestrial network and/or a non-terrestrial network. The non-terrestrial network may operate based on at least one communication technology among the LTE communication technology, 5G communication technology, or 6G communication technology. The non-terrestrial network may provide communication services in various frequency bands.

The communication network to which exemplary embodiments are applied is not limited to the content described below, and the exemplary embodiments may be applied to various communication networks (e.g. 4G communication network, 5G communication network, and/or 6G communication network). Here, a communication network may be used in the same sense as a communication system.

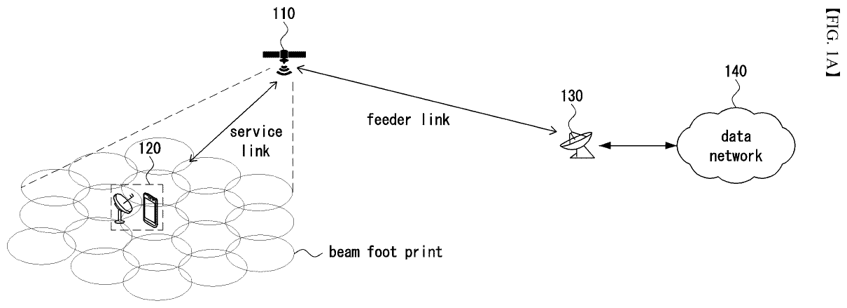

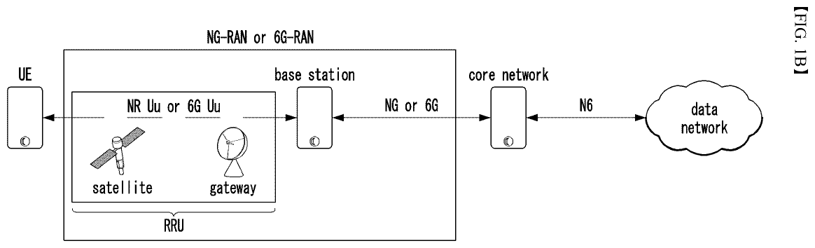

FIG. 1A is a conceptual diagram illustrating a first exemplary embodiment of a non-terrestrial network.

As shown in FIG. 1A, a non-terrestrial network (NTN) may include a satellite 110, a communication node 120, a gateway 130, a data network 140, and the like. A unit including the satellite 110 and the gateway 130 may correspond to a remote radio unit (RRU). The NTN shown in FIG. 1A may be an NTN based on a transparent payload. The satellite 110 may be a low earth orbit (LEO) satellite, a medium earth orbit (MEO) satellite, a geostationary earth orbit (GEO) satellite, a high elliptical orbit (HEO) satellite, or an unmanned aircraft system (UAS) platform. The UAS platform may include a high altitude platform station (HAPS). A non-GEO satellite may be an LEO satellite and/or MEO satellite.

The communication node 120 may include a communication node (e.g. a user equipment (UE) or a terminal) located on a terrestrial site and a communication node (e.g. an airplane, a drone) located on a non-terrestrial space. A service link may be established between the satellite 110 and the communication node 120, and the service link may be a radio link. The satellite 110 may provide communication services to the communication node 120 using one or more beams. The shape of a footprint of the beam of the satellite 110 may be elliptical or circular.

In the non-terrestrial network, three types of service links can be supported as follows.
Earth-fixed: a service link may be provided by beam(s) that continuously cover the same geographic area at all times (e.g. geosynchronous orbit (GSO) satellite).
quasi-earth-fixed: a service link may be provided by beam(s) covering one geographical area during a limited period and provided by beam(s) covering another geographical area during another period (e.g. non-GSO (NGSO) satellite forming steerable beams).
earth-moving: a service link may be provided by beam(s) moving over the Earth's surface (e.g. NGSO satellite forming fixed beams or non-steerable beams).

The communication node 120 may perform communications (e.g. downlink communication and uplink communication) with the satellite 110 using 4G communication technology, 5G communication technology, and/or 6G communication technology. The communications between the satellite 110 and the communication node 120 may be performed using an NR-Uu interface and/or 6G-Uu interface. When dual connectivity (DC) is supported, the communication node 120 may be connected to other base stations (e.g. base stations supporting 4G, 5G, and/or 6G functionality) as well as the satellite 110, and perform DC operations based on the techniques defined in 4G, 5G, and/or 6G technical specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface, a 6G-Uu interface, or a satellite radio interface (SRI). The gateway 130 may be connected to the data network 140. There may be a ‘core network’ between the gateway 130 and the data network 140. In this case, the gateway 130 may be connected to the core network, and the core network may be connected to the data network 140. The core network may support the 4G communication technology, 5G communication technology, and/or 6G communication technology. For example, the core network may include an access and mobility management function (AMF), a user plane function (UPF), a session management function (SMF), and the like. The communications between the gateway 130 and the core network may be performed based on an NG-C/U interface or 6G-C/U interface.

As shown in an exemplary embodiment of FIG. 1B, there may be a ‘core network’ between the gateway 130 and the data network 140 in a transparent payload-based NTN.

FIG. 1B is a conceptual diagram illustrating a second exemplary embodiment of a non-terrestrial network.

As shown in FIG. 1B, the gateway may be connected with the base station, the base station may be connected with the core network, and the core network may be connected with the data network. Each of the base station and core network may support the 4G communication technology, 5G communication technology, and/or 6G communication technology. The communications between the gateway and the base station may be performed based on an NR-Uu interface or 6G-Uu interface, and the communications between the base station and the core network (e.g. AMF, UPF, SMF, and the like) may be performed based on an NG-C/U interface or 6G-C/U interface.

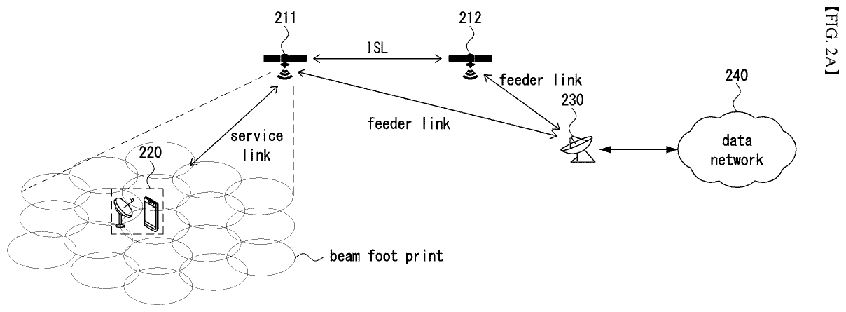

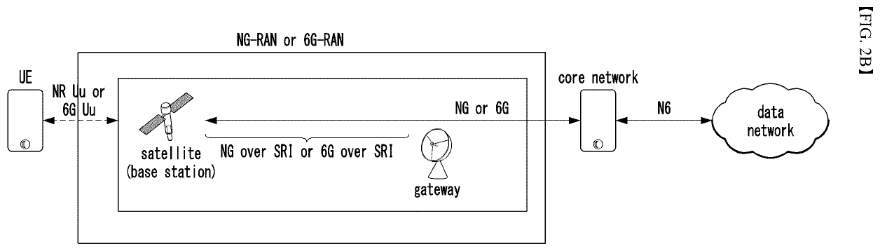

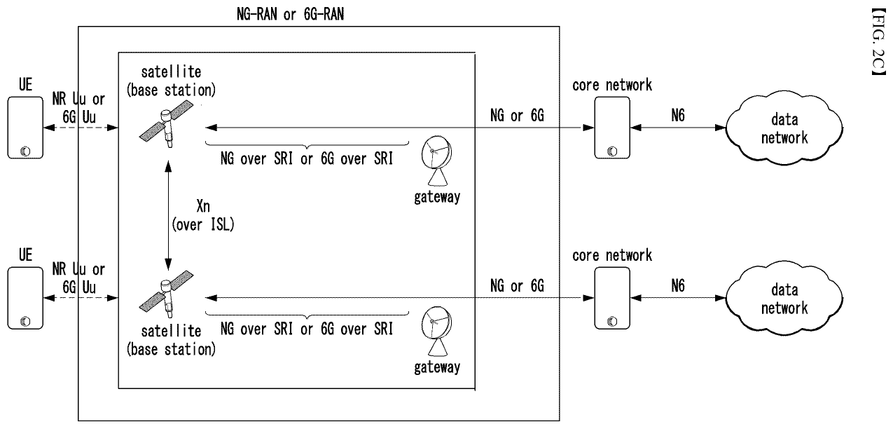

FIG. 2A is a conceptual diagram illustrating a third exemplary embodiment of a non-terrestrial network.

As shown in FIG. 2A, a non-terrestrial network may include a first satellite 211, a second satellite 212, a communication node 220, a gateway 230, a data network 240, and the like. The NTN shown in FIG. 2A may be a regenerative payload based NTN. For example, each of the satellites 211 and 212 may perform a regenerative operation (e.g. demodulation, decoding, re-encoding, re-modulation, and/or filtering operation) on a payload received from other entities (e.g. the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g. UE or terminal) and a non-terrestrial communication node (e.g. airplane or drone). A service link (e.g. radio link) may be established between the satellite 211 and communication node 220. The satellite 211 may provide communication services to the communication node 220 using one or more beams.

The communication node 220 may perform communications (e.g. downlink communication or uplink communication) with the satellite 211 using the 4G communication technology, 5G communication technology, and/or 6G communication technology. The communications between the satellite 211 and the communication node 220 may be performed using an NR-Uu interface or 6G-Uu interface. When DC is supported, the communication node 220 may be connected to other base stations (e.g. base stations supporting 4G, 5G, and/or 6G functionality) as well as the satellite 211, and may perform DC operations based on the techniques defined in 4G, 5G, and/or 6G technical specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily. The communications between each of the satellites 211 and 212 and the gateway 230 may be performed based on an NR-Uu interface, a 6G-Uu interface, or an SRI. The gateway 230 may be connected to the data network 240.

As shown in exemplary embodiments of FIG. 2B and FIG. 2C, there may be a ‘core network’ between the gateway 230 and the data network 240.

FIG. 2B is a conceptual diagram illustrating a fourth exemplary embodiment of a non-terrestrial network, and FIG. 2C is a conceptual diagram illustrating a fifth exemplary embodiment of a non-terrestrial network.

As shown in FIG. 2B and FIG. 2C, the gateway may be connected with the core network, and the core network may be connected with the data network. The core network may support the 4G communication technology, 5G communication technology, and/or 6G communication technology. For example. The core network may include AMF, UPF, SMF, and the like. Communication between the gateway and the core network may be performed based on an NG-C/U interface or 6G-C/U interface. Functions of a base station may be performed by the satellite. That is, the base station may be located on the satellite. A payload may be processed by the base station located on the satellite. Base stations located on different satellites may be connected to the same core network. One satellite may have one or more base stations. In the non-terrestrial network of FIG. 2B, an ISL between satellites may not be established, and in the non-terrestrial network of FIG. 2C, an ISL between satellites may be established.

Meanwhile, the entities (e.g. satellite, base station, UE, communication node, gateway, and the like) constituting the non-terrestrial network shown in FIGS. 1A, 1B, 2A, 2B, and/or 2C may be configured as follows. In the present disclosure, the entity may be referred to as a communication node.

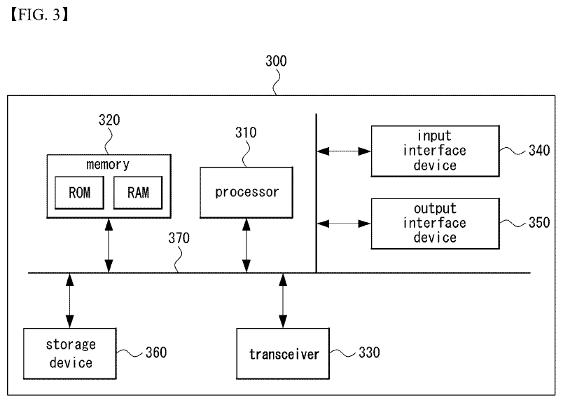

FIG. 3 is a block diagram illustrating a first exemplary embodiment of a communication node constituting a non-terrestrial network.

As shown in FIG. 3, a communication node 300 may include at least one processor 310, a memory 320, and a transceiver 330 connected to a network to perform communication. In addition, the communication node 300 may further include an input interface device 340, an output interface device 350, a storage device 360, and the like. The components included in the communication node 300 may be connected by a bus 370 to communicate with each other.

However, each component included in the communication node 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

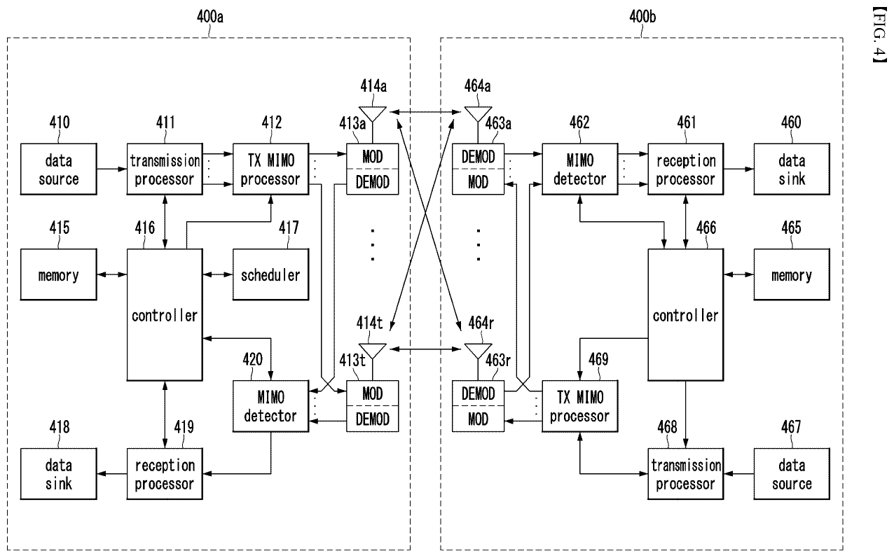

Meanwhile, communication nodes that perform communications in the communication network (e.g. non-terrestrial network) may be configured as follows. A communication node shown in FIG. 4 may be a specific exemplary embodiment of the communication node shown in FIG. 3.

FIG. 4 is a block diagram illustrating a first exemplary embodiment of communication nodes performing communication.

As shown in FIG. 4, each of a first communication node 400a and a second communication node 400b may be a base station or UE. The first communication node 400a may transmit a signal to the second communication node 400b. A transmission processor 411 included in the first communication node 400a may receive data (e.g. data unit) from a data source 410. The transmission processor 411 may receive control information from a controller 416. The control information may include at least one of system information, RRC configuration information (e.g. information configured by RRC signaling), MAC control information (e.g. MAC CE), or PHY control information (e.g. DCI, SCI).

The transmission processor 411 may generate data symbol(s) by performing processing operations (e.g. encoding operation, symbol mapping operation, etc.) on the data. The transmission processor 411 may generate control symbol(s) by performing processing operations (e.g. encoding operation, symbol mapping operation, etc.) on the control information. In addition, the transmission processor 411 may generate synchronization/reference symbol(s) for synchronization signals and/or reference signals.

A Tx MIMO processor 412 may perform spatial processing operations (e.g. precoding operations) on the data symbol(s), control symbol(s), and/or synchronization/reference symbol(s). An output (e.g. symbol stream) of the Tx MIMO processor 412 may be provided to modulators (MODs) included in transceivers 413a to 413t. The modulator may generate modulation symbols by performing processing operations on the symbol stream, and may generate signals by performing additional processing operations (e.g. analog conversion operations, amplification operation, filtering operation, up-conversion operation, etc.) on the modulation symbols. The signals generated by the modulators of the transceivers 413a to 413t may be transmitted through antennas 414a to 414t.

The signals transmitted by the first communication node 400a may be received at antennas 464a to 464r of the second communication node 400b. The signals received at the antennas 464a to 464r may be provided to demodulators (DEMODs) included in transceivers 463a to 463r. The demodulator (DEMOD) may obtain samples by performing processing operations (e.g. filtering operation, amplification operation, down-conversion operation, digital conversion operation, etc.) on the signals. The demodulator may perform additional processing operations on the samples to obtain symbols. A MIMO detector 462 may perform MIMO detection operations on the symbols. A reception processor 461 may perform processing operations (e.g. de-interleaving operation, decoding operation, etc.) on the symbols. An output of the reception processor 461 may be provided to a data sink 460 and a controller 466. For example, the data may be provided to the data sink 460 and the control information may be provided to the controller 466.

On the other hand, the second communication node 400b may transmit signals to the first communication node 400a. A transmission processor 469 included in the second communication node 400b may receive data (e.g. data unit) from a data source 467 and perform processing operations on the data to generate data symbol(s). The transmission processor 468 may receive control information from the controller 466 and perform processing operations on the control information to generate control symbol(s). In addition, the transmission processor 468 may generate reference symbol(s) by performing processing operations on reference signals.

A Tx MIMO processor 469 may perform spatial processing operations (e.g. precoding operations) on the data symbol(s), control symbol(s), and/or reference symbol(s). An output (e.g. symbol stream) of the Tx MIMO processor 469 may be provided to modulators (MODs) included in the transceivers 463a to 463t. The modulator may generate modulation symbols by performing processing operations on the symbol stream, and may generate signals by performing additional processing operations (e.g. analog conversion operation, amplification operation, filtering operation, up-conversion operations) on the modulation symbols. The signals generated by the modulators of the transceivers 463a to 463t may be transmitted through the antennas 464a to 464t.

The signals transmitted by the second communication node 400b may be received at the antennas 414a to 414r of the first communication node 400a. The signals received at the antennas 414a to 414r may be provided to demodulators (DEMODs) included in the transceivers 413a to 413r. The demodulator may obtain samples by performing processing operations (e.g. filtering operation, amplification operation, down-conversion operation, digital conversion operation) on the signals. The demodulator may perform additional processing operations on the samples to obtain symbols. A MIMO detector 420 may perform a MIMO detection operation on the symbols. The reception processor 419 may perform processing operations (e.g. de-interleaving operation, decoding operation, etc.) on the symbols. An output of the reception processor 419 may be provided to a data sink 418 and the controller 416. For example, the data may be provided to the data sink 418 and the control information may be provided to the controller 416.

Memories 415 and 465 may store the data, control information, and/or program codes. A scheduler 417 may perform scheduling operations for communication. The processors 411, 412, 419, 461, 468, and 469 and the controllers 416 and 466 shown in FIG. 4 may be the processor 310 shown in FIG. 3, and may be used to perform methods described in the present disclosure.

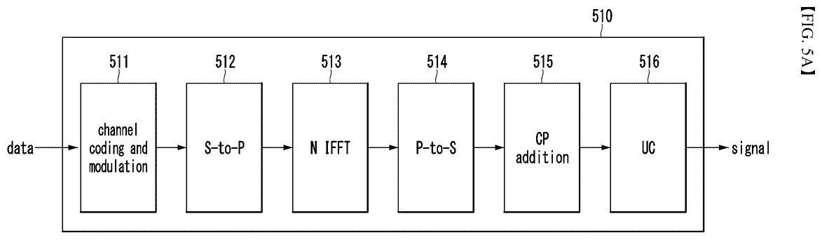

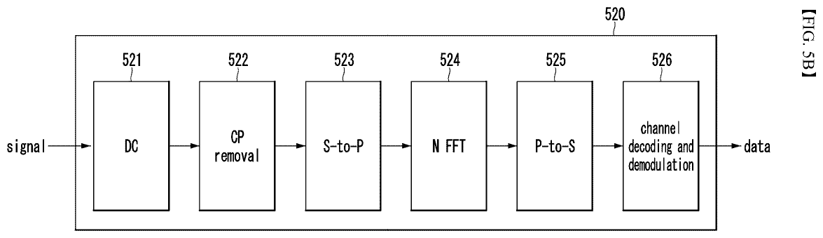

FIG. 5A is a block diagram illustrating a first exemplary embodiment of a transmission path, and FIG. 5B is a block diagram illustrating a first exemplary embodiment of a reception path.

As shown in FIGS. 5A and 5B, a transmission path 510 may be implemented in a communication node that transmits signals, and a reception path 520 may be implemented in a communication node that receives signals. The transmission path 510 may include a channel coding and modulation block 511, a serial-to-parallel (S-to-P) block 512, an N-point inverse fast Fourier transform (N-point IFFT) block 513, a parallel-to-serial (P-to-S) block 514, a cyclic prefix (CP) addition block 515, and up-converter (UC) 516. The reception path 520 may include a down-converter (DC) 521, a CP removal block 522, an S-to-P block 523, an N-point FFT block 524, a P-to-S block 525, and a channel decoding and demodulation block 526. Here, N may be a natural number.

In the transmission path 510, information bits may be input to the channel coding and modulation block 511. The channel coding and modulation block 511 may perform a coding operation (e.g. low-density parity check (LDPC) coding operation, polar coding operation, etc.) and a modulation operation (e.g. Quadrature Phase Shift Keying (OPSK), Quadrature Amplitude Modulation (QAM), etc.) on the information bits. An output of the channel coding and modulation block 511 may be a sequence of modulation symbols.

The S-to-P block 512 may convert frequency domain modulation symbols into parallel symbol streams to generate N parallel symbol streams. N may be the IFFT size or the FFT size. The N-point IFFT block 513 may generate time domain signals by performing an IFFT operation on the N parallel symbol streams. The P-to-S block 514 may convert the output (e.g., parallel signals) of the N-point IFFT block 513 to serial signals to generate the serial signals.

The CP addition block 515 may insert a CP into the signals. The UC 516 may up-convert a frequency of the output of the CP addition block 515 to a radio frequency (RF) frequency. Further, the output of the CP addition block 515 may be filtered in baseband before the up-conversion.

The signal transmitted from the transmission path 510 may be input to the reception path 520. Operations in the reception path 520 may be reverse operations for the operations in the transmission path 510. The DC 521 may down-convert a frequency of the received signals to a baseband frequency. The CP removal block 522 may remove a CP from the signals. The output of the CP removal block 522 may be serial signals. The S-to-P block 523 may convert the serial signals into parallel signals. The N-point FFT block 524 may generate N parallel signals by performing an FFT algorithm. The P-to-S block 525 may convert the parallel signals into a sequence of modulation symbols. The channel decoding and demodulation block 526 may perform a demodulation operation on the modulation symbols and may restore data by performing a decoding operation on a result of the demodulation operation.

In FIGS. 5A and 5B, discrete Fourier transform (DFT) and inverse DFT (IDFT) may be used instead of FFT and IFFT. Each of the blocks (e.g. components) in FIGS. 5A and 5B may be implemented by at least one of hardware, software, or firmware. For example, some blocks in FIGS. 5A and 5B may be implemented by software, and other blocks may be implemented by hardware or a combination of hardware and software. In FIGS. 5A and 5B, one block may be subdivided into a plurality of blocks, a plurality of blocks may be integrated into one block, some blocks may be omitted, and blocks supporting other functions may be added.

Meanwhile, NTN reference scenarios may be defined as shown in Table 1 below.

TABLE 1

| | NTN shown in FIG. 1 | NTN shown in FIG. 2 |
|---|---|---|
| GEO | Scenario A | Scenario B |
| LEO (steerable | Scenario C1 | Scenario D1 |
| beams) | | |
| LEO (beams | Scenario C2 | Scenario D2 |
| moving with | | |
| satellite) | | |

When the satellite 110 in the NTN shown in FIG. 1A and/or FIG. 1B is a GEO satellite (e.g. a GEO satellite that supports a transparent function), this may be referred to as ‘scenario A’. When the satellites 211 and 212 in the NTN shown in FIG. 2A, FIG. 2B, and/or FIG. 2C are GEO satellites (e.g. GEOs that support a regenerative function), this may be referred to as ‘scenario B’.

When the satellite 110 in the NTN shown in FIG. 1A and/or FIG. 1B is an LEO satellite with steerable beams, this may be referred to as ‘scenario C1’. When the satellite 110 in the NTN shown in FIG. 1A and/or FIG. 1B is an LEO satellite having beams moving with the satellite, this may be referred to as ‘scenario C2’. When the satellites 211 and 212 in the NTN shown in FIG. 2A, FIG. 2B, and/or FIG. 2C are LEO satellites with steerable beams, this may be referred to as ‘scenario D1’. When the satellites 211 and 212 in the NTN shown in FIG. 2A, FIG. 2B, and/or FIG. 2C are LEO satellites having beams moving with the satellites, this may be referred to as ‘scenario D2’.

Parameters for the NTN reference scenarios defined in Table 1 may be defined as shown in Table 2 below.

TABLE 2

| | Scenarios A and B | | Scenarios C and D | |
|---|---|---|---|---|
| Altitude | 35,786 | km | 600 | km |
| | | | 1,200 | km |
| Spectrum (service link) | <6 GHz (e.g. 2 GHz) | | | |
| | >6 GHz (e.g. DL 20 GHz, UL 30 GHz) | | | |
| Maximum channel | 30 MHz for band <6 GHz | | | |
| bandwidth capability | 1 GHz for band >6 GHz | | | |
| (service link) | | | | |

| Maximum distance between | 40,581 | km | 1,932 km (altitude of 600 |
|---|---|---|---|
| satellite and communication | | | km) |
| node (e.g. UE) at the | | | 3,131 km (altitude of 1,200 |
| minimum elevation angle | | | km) |
| Maximum round trip delay | Scenario A: 541.46 ms | | Scenario C: (transparent |
| (RTD) (only propagation | (service and feeder links) | | payload: service and feeder |
| delay) | Scenario B: 270.73 ms | | links) |
| | (only service link) | | −5.77 ms (altitude of 60 0 km) |
| | | | −41.77 ms (altitude of 1,200 |
| | | | km) |
| | | | Scenario D: (regenerative |
| | | | payload: only service link) |
| | | | −12.89 ms (altitude of 600 |
| | | | km) |
| | | | −20.89 ms (altitude of 1,200 |
| | | | km) |
| Maximum differential | 10.3 | ms | 3.12 ms (altitude of 600 km) |
| delay within a cell | | | 3.18 ms (altitude of 1,200 |
| | | | km) |

| | |
|---|---|
| Service link | NR defined in 3GPP |
| Feeder link | Radio interfaces defined in 3GPP or non-3GPP |

In addition, in the scenarios defined in Table 1, delay constraints may be defined as shown in Table 3 below.

TABLE 3

| | Scenario | Scenario | Scenario | | Scenario | |
|---|---|---|---|---|---|---|
| | A | B | C1-2 | | D1-2 | |
| Satellite altitude | 35,786 km | | 600 km | | | |
| Maximum RTD in a | 541.75 ms | 270.57 ms | 28.41 | ms | 12.88 | ms |
| radio interface | (worst case) | | | | | |
| between base station | | | | | | |
| and UE | | | | | | |
| Minimum RTD in a | 477.14 ms | 238.57 ms | 8 | ms | 4 | ms |
| radio interface | | | | | | |
| between base station | | | | | | |
| and UE | | | | | | |

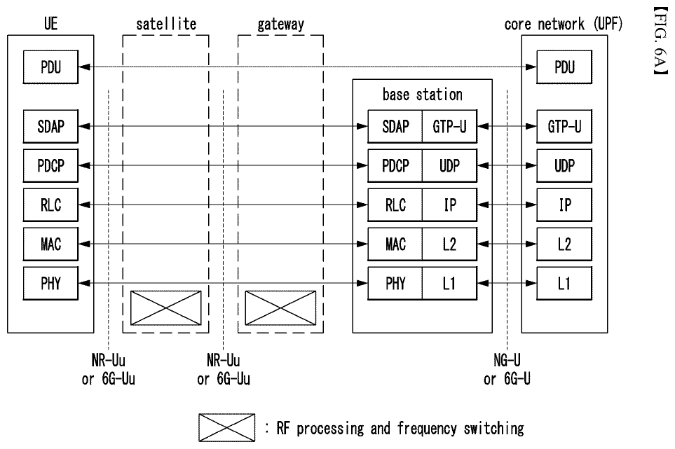

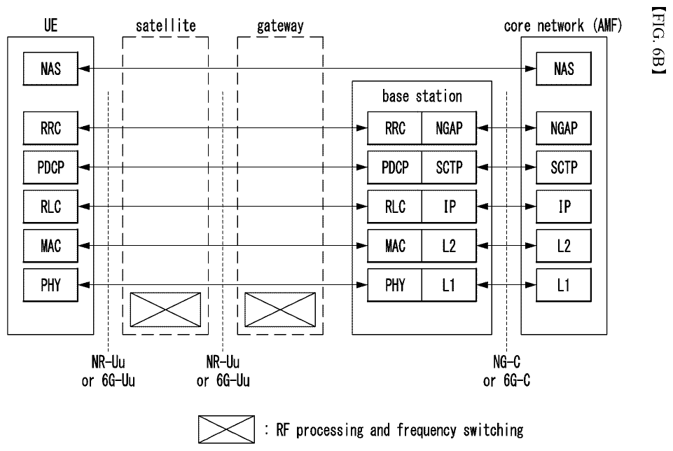

FIG. 6A is a conceptual diagram illustrating a first exemplary embodiment of a protocol stack of a user plane in a transparent payload-based non-terrestrial network, and FIG. 6B is a conceptual diagram illustrating a first exemplary embodiment of a protocol stack of a control plane in a transparent payload-based non-terrestrial network.

As shown in FIGS. 6A and 6B, user data may be transmitted and received between a UE and a core network (e.g. UPF), and control data (e.g. control information) may be transmitted and received between the UE and the core network (e.g. AMF). Each of the user data the and control data may be transmitted and received through a satellite and/or gateway. The protocol stack of the user plane shown in FIG. 6A may be applied identically or similarly to a 6G communication network. The protocol stack of the control plane shown in FIG. 6B may be applied identically or similarly to a 6G communication network.

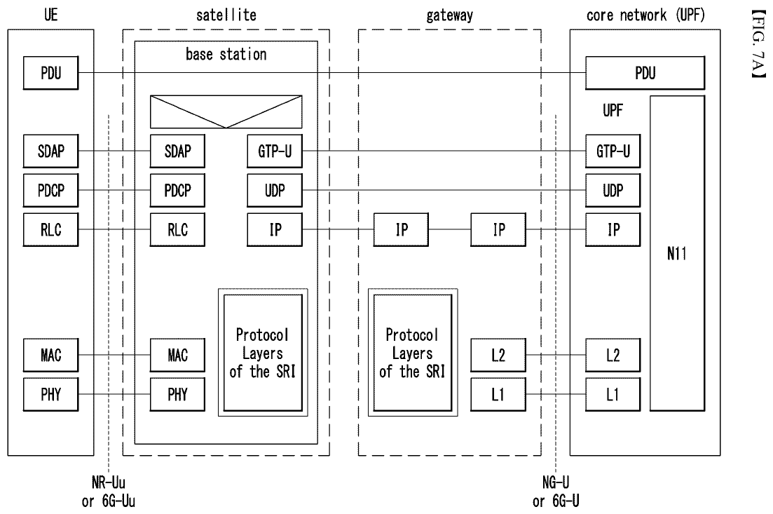

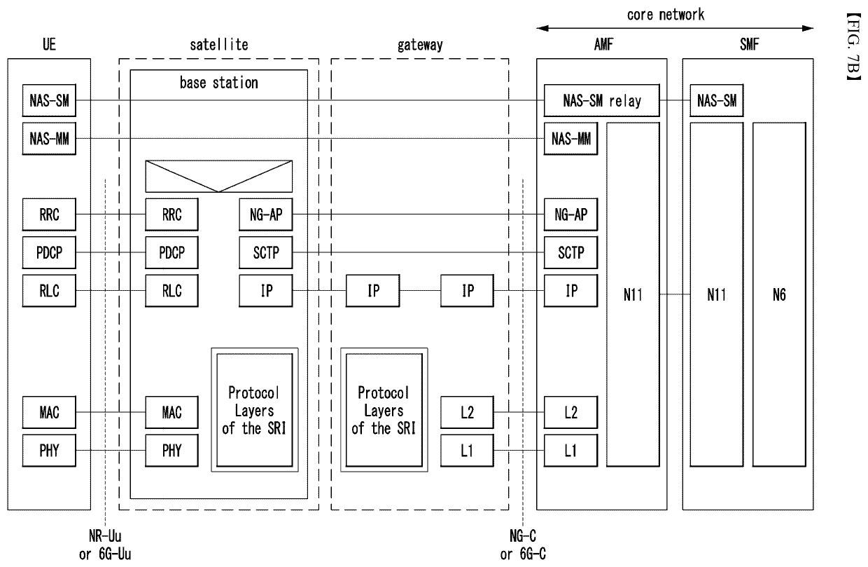

FIG. 7A is a conceptual diagram illustrating a first exemplary embodiment of a protocol stack of a user plane in a regenerative payload-based non-terrestrial network, and FIG. 7B is a conceptual diagram illustrating a first exemplary embodiment of a protocol stack of a control plane in a regenerative payload-based non-terrestrial network.

As shown in FIGS. 7A and 7B, each of user data and control data (e.g. control information) may be transmitted and received through an interface between a UE and a satellite (e.g. base station). The user data may refer to a user protocol data unit (PDU). A protocol stack of a satellite radio interface (SRI) may be used to transmit and receive the user data and/or control data between the satellite and a gateway. The user data may be transmitted and received through a general packet radio service (GPRS) tunneling protocol (GTP)-U tunnel between the satellite and a core network.

Meanwhile, in a non-terrestrial network, a base station may transmit system information (e.g. SIB19) including satellite assistance information for NTN access. A UE may receive the system information (e.g. SIB19) from the base station, identify the satellite assistance information included in the system information, and perform communication (e.g. non-terrestrial communication) based on the satellite assistance information. The SIB19 may include information element(s) defined in Table 4 below.

TABLE 4
SIB19-r17 ::= SEQUENCE {

| | |
|---|---|
| ntn-Config-r17 | NTN-Config-r17 |
| t-Service-r17 | INTEGER(0..549755813887) |
| referenceLocation-r17 | ReferenceLocation-r17 |
| distanceThresh-r17 | INTEGER(0..65525) |
| ntn-NeighCellConfigList-r17 | NTN-NeighCellConfigList-r17 |
| lateNonCriticalExtension | OCTET STRING |

```
  ...,
  [[
```

| | |
|---|---|
| ntn-NeighCellConfigListExt-v1720 | NTN-NeighCellConfigList-r17 |

]]
}

| | |
|---|---|
| NTN-NeighCellConfigList-r17 ::= | SEQUENCE (SIZE(1..maxCellNTN-r17)) |

OF NTN-NeighCellConfig-r17

| | |
|---|---|
| NTN-NeighCellConfig-r17 ::= | SEQUENCE { |
| ntn-Config-r17 | NTN-Config-r17 |
| carrierFreq-r17 | ARFCN-ValueNR |
| physCellId-r17 | PhysCellId |

}

NTN-Config defined in Table 4 may include information element(s) defined in Table 5 below.

TABLE 5

| | |
|---|---|
| NTN-Config-r17 ::= | SEQUENCE { |
| epochTime-r17 | EpochTime-r17 |

ntn-UlSyncValidityDuration-r17 ENUMERATED{ s5, s10, s15, s20, s25, s30, s35,
s40, s45, s50, s55, s60, s120, s180, s240, s900}

| | |
|---|---|
| cellSpecificKoffset-r17 | INTEGER(1..1023) |
| kmac-r17 | INTEGER(1..512) |
| ta-Info-r17 | TA-Info-r17 |
| ntn-PolarizationDL-r17 | ENUMERATED {rhcp,lhcp,linear} |
| ntn-PolarizationUL-r17 | ENUMERATED {rhcp,lhcp,linear} |
| ephemerisInfo-r17 | EphemerisInfo-r17 |
| ta-Report-r17 | ENUMERATED {enabled} |

...
}

| | |
|---|---|
| EpochTime-r17 ::= | SEQUENCE { |
| sfn-r17 | INTEGER(0..1023), |
| subFrameNR-r17 | INTEGER(0..9) |

}

| | |
|---|---|
| TA-Info-r17 ::= | SEQUENCE { |
| ta-Common-r17 | INTEGER(0..66485757), |
| ta-CommonDrift-r17 | INTEGER(−257303..257303) |
| ta-CommonDriftVariant-r17 | INTEGER(0..28949) |

}

TABLE 6

| | |
|---|---|
| EphemerisInfo-r17 ::= | CHOICE { |
| positionVelocity-r17 | PositionVelocity-r17, |
| orbital-r17 | Orbital-r17 |

}

| | |
|---|---|
| PositionVelocity-r17 ::= | SEQUENCE { |
| positionX-r17 | PositionStateVector-r17, |
| positionY-r17 | PositionStateVector-r17, |
| positionZ-r17 | PositionStateVector-r17, |
| velocityVX-r17 | VelocityStateVector-r17, |
| velocityVY-r17 | VelocityStateVector-r17, |
| velocityVZ-r17 | VelocityStateVector-r17 |

}

| | |
|---|---|
| Orbital-r17 ::= | SEQUENCE { |
| semiMajorAxis-r17 | INTEGER (0..8589934591), |
| eccentricity-r17 | INTEGER (0..1048575), |
| periapsis-r17 | INTEGER (0..268435455), |
| longitude-r17 | INTEGER (0..268435455), |
| inclination-r17 | INTEGER (−67108864..67108863), |
| meanAnomaly-r17 | INTEGER (0..268435455) |

}
PositionStateVector-r17 ::= INTEGER (−33554432..33554431)
VelocityStateVector-r17 ::= INTEGER (−131072..131071)

A non-terrestrial network may support voice call services. In the non-terrestrial network, a terminal may transmit packets (e.g. voice packets) to a base station through an uplink channel (e.g. physical uplink shared channel (PUSCH)). In a transparent payload-based non-terrestrial network, the base station may be located on the ground. In this case, packets transmitted by the terminal may be delivered to the base station through a path of (terminal→satellite→gateway→base station), and packets transmitted by the base station may be delivered to the terminal through a path of (base station→gateway→satellite→terminal). In a regenerative payload-based non-terrestrial network, the base station may be located on the satellite. In this case, communication between the terminal and the base station may mean communication between the terminal and the satellite. In the present disclosure, a packet may refer to a voice packet, a video packet, or the like.

In a non-terrestrial network, very large propagation delays may occur. To satisfy the low latency requirements for voice call services in the non-terrestrial network, voice packets may be retransmitted repeatedly. Repeated retransmission of voice packets may improve transmission reliability. HARQ retransmission operations may not be applied in voice call services.

For encoding of packets (e.g. voice packets) in the non-terrestrial network, an adaptive multi-rate (AMR) codec may be used. The AMR codec may support various modes, as shown in Table 7 below. AMR_4.75 may be supported in the non-terrestrial network.

TABLE 7

| Mode | Bitrate (kbits/s) |
|---|---|
| AMR_12.20 | 12.20 |
| AMR_10.20 | 10.20 |
| AMR_7.95 | 7.95 |
| AMR_7.40 | 7.40 |
| AMR_6.70 | 6.70 |
| AMR_5.90 | 5.90 |
| AMR_5.15 | 5.15 |
| AMR_4.75 | 4.75 |
| AMR_SID | 1.80 |

When voice data (e.g. payload) is generated in the terminal, a medium access control (MAC) layer of the terminal may generate a MAC protocol data unit (MPDU) including the voice data and deliver the MPDU to a physical (PHY) layer of the terminal. The PHY layer of the terminal may receive the MPDU from the MAC layer of the terminal, generate a physical PDU (PPDU) based on the MPDU, and transmit the PPDU to the base station. The PPDU including the voice data may be a voice packet. A structure of the MPDU including voice data may be as shown in Table 8 below.

TABLE 8

| | | |
|---|---|---|
| MAC | 16 bits | 184 bits |
| | (w/12 bits SN) | |
| RLC | 8 bits | |
| | (w/6 bits SN) | |
| PDCP | 16 bits | |
| RTP/UDP/IP | 24 bits (w/RoHC) | |
| AMR header + | 120 bits (w/AMR payload 95 bits) | |
| AMR payload | | |

The AMR payload may be the voice data. The PPDU (e.g. voice packet) may include a PHY header, an MPDU specified in Table 8, and a cyclic redundancy check (CRC) field. The size of the CRC field (e.g. CRC bits) may be 16 bits. A generation periodicity (or transmission periodicity) of the voice packet (e.g. MPDU including voice data) may be 20 ms. Since the size of header in the voice packet is significant, the overhead caused by the header may be large. This overhead may reduce transmission efficiency, necessitating methods to address this issue.

Meanwhile, in a conventional terrestrial network, handovers may occur due to individual movements of terminals. In other words, a handover procedure may be performed per terminal according to individual movements of the terminals. In this case, when a handover procedure occurs, the handover procedure may include at least one of a handover-related signal strength measurement, a handover-related signal strength reporting, a handover request, a handover acknowledgement, or a handover command procedure. In this case, signaling overhead may occur in a satellite while handling the handover acknowledgement or the handover command procedure.

Meanwhile, in a non-terrestrial network, handovers may occur due to movement of a satellite. Handovers in the non-terrestrial network may occur simultaneously from a large number of terminals. In addition, the handovers in the non-terrestrial network may occur frequently due to a high speed of the satellite. Therefore, since the satellite and a base station in the non-terrestrial network process handovers for a large number of terminals simultaneously, signaling overhead may occur. The present disclosure proposes group-based handover processing methods as methods for reducing the overhead occurring in processing handovers in the non-terrestrial network.

The group-based handover processing methods may include methods for group configuration and methods for reducing handover overhead based on the group configuration. In this case, since handovers occur according to the movement of the satellite in the non-terrestrial network environment, the group-based handover processing methods may consider the movement of the satellite. The movement of the satellite may vary depending on a satellite system in the non-terrestrial network. In addition, the satellite system in the non-terrestrial network may vary depending on the movement of the satellite. In this case, an area supported by the satellite for providing services may be referred to as a beam spot or a beam area. The beam area may be referred to as a beam footprint. A beam footprint generated by the satellite may vary on the ground depending on the movement of the satellite. According to the change of the beam footprint in the non-terrestrial network, the satellite system may be classified into two scenarios. The two scenarios may include an earth fixed beam (EFB) scenario and an earth moving beam (EMB) scenario. In this case, the present disclosure may apply different group configuration methods to the EFB scenario and the EMB scenario.

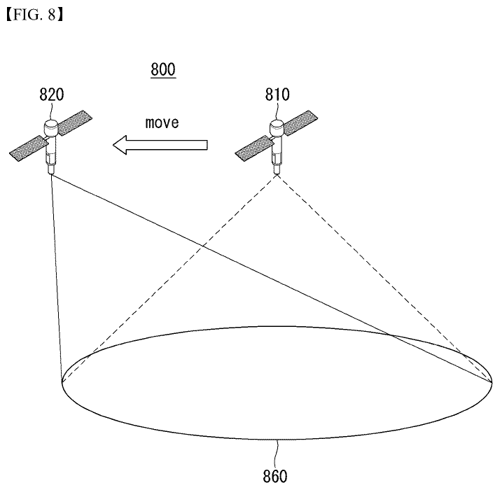

FIG. 8 is a conceptual diagram for describing EFB.

As shown in FIG. 8, a beam of a satellite may have EFB characteristics. FIG. 8 may represent a characteristic of maintaining a cell coverage regardless of a movement of the satellite in an EFB environment.

In the EFB environment, even when a satellite (located at 810 or 820) moves, an existing beam coverage 860 on the ground may be maintained. The beam coverage may be referred to as a cell area (cell coverage) on the ground. In the EFB environment, the satellite at 810 or 820 may maintain the cell area fixedly through beam steering or beam switching. As the satellite moves, a new satellite may provide services to the cell area. When the new satellite starts to provide services to the cell area, an elevation angle between the cell area and the new satellite may be the smallest. The elevation angle may increase as the satellite moves. After the elevation angle increases, the elevation angle may decrease again as the satellite moves further. In this case, a distance between the satellite and the cell may decrease or increase according to the change in the elevation angle.

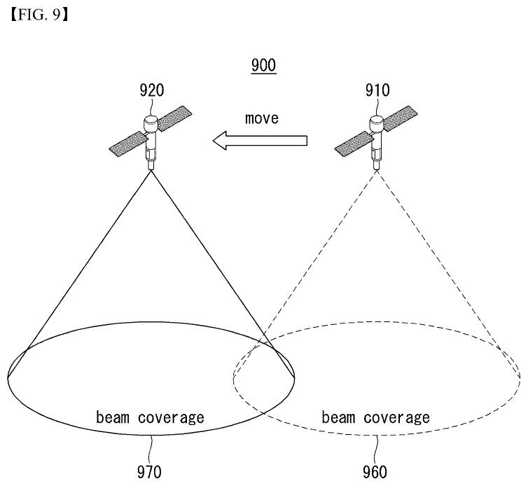

FIG. 9 is a conceptual diagram for describing EMB.

As shown in FIG. 9, a beam of a satellite may have EMB characteristics. FIG. 9 may represent a characteristic in which a beam coverage changes according to movement of the satellite in an EMB environment.

In the EMB environment, when a satellite (located at 910 or 920) moves, a cell area 960 or 970 on the ground may change according to the movement of the satellite. Therefore, a satellite serving terminals in a specific area may be continuously changed. In this case, terminals included in a beam coverage of a specific satellite may have different data service times according to a location of the beam coverage. In other words, remaining cell times of the terminals may differ depending on locations of the terminals. The remaining cell time may refer to a remaining time during which a terminal is served in the corresponding cell according to a location of the terminal within the beam coverage. In other words, the remaining cell time may be a time during which communication services can be provided to the terminal in the cell where the terminal is located. When the remaining cell time (e.g. remaining cell service time) expires, the terminal may perform a procedure of (re)selecting another cell. The remaining cell time may be referred to as a remaining time.

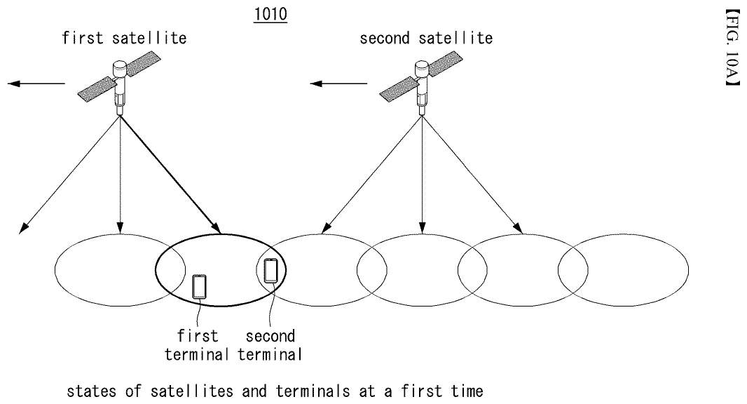

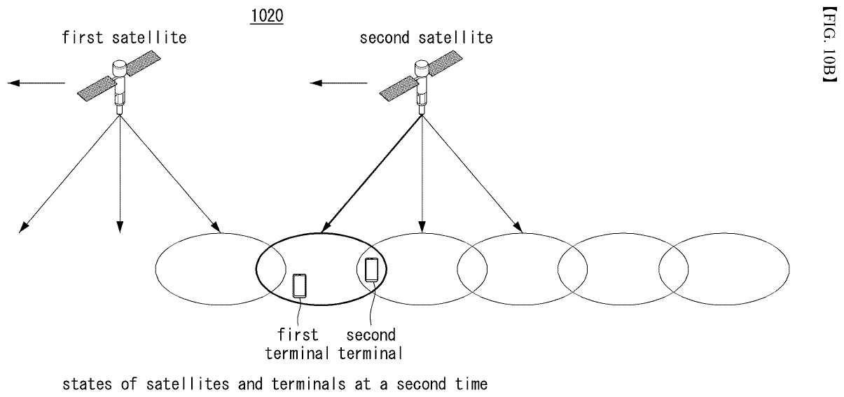

FIG. 10A is a conceptual diagram illustrating a first exemplary embodiment of a handover procedure.

As shown in FIG. 10A, satellites (i.e. first satellite, second satellite) may form cell coverages in an EFB environment. In this case, the beam coverage may be formed by at least one beam area (e.g. beam spot). The beam area may refer to an area covered by one beam. In other words, the satellite may form one or more beam areas (beam spots).

In the EFB environment, all terminals located in the same beam area may request handover procedures from the satellite at the same or similar time. When the terminals are included in the same beam area, the terminals may have the same value of the remaining cell time. Through the same value of the remaining cell time, the satellite may configure all terminals in the same beam area as the same group.

The satellite may transmit a paging message to terminals in one beam area. The satellite may transmit one paging message to terminals in multiple beam areas. The paging message may include a group identifier. A different group identifier may be assigned to each beam area. For example, the satellite may transmit a paging message to 5 beam areas. In this case, group identifiers for groups of terminals belonging to different beam areas among the 5 beam areas may be different from one another. Terminals in one beam area may receive the same group identifier from the satellite.

FIG. 10B is a conceptual diagram illustrating a second exemplary embodiment of a handover procedure.

As shown in FIGS. 10A and 10B, in an EFB-based non-terrestrial network (hereinafter referred to as ‘EFB non-terrestrial network’), each of the first satellite and the second satellite may move over time (e.g. from a first time to a second time), and may support EFB(s). The second time may be after the first time. Handover procedures may be classified into an intra-satellite (intra-SAT) handover procedure and an inter-satellite (inter-SAT) handover procedure. Each of the intra-SAT handover procedure and the inter-SAT handover procedure may be a general handover procedure or a conditional handover (CHO) procedure. In the intra-SAT handover procedure, terminal(s) may perform handover procedure(s) for cells of the same satellite. In other words, the intra-SAT handover procedure may be performed through beam switching at the same satellite. For example, in the intra-SAT handover procedure, all terminals connected to a first cell of the first satellite may be handed over to a second cell of the first satellite. In this case, all terminals may be handed over to the second cell at the same or similar time. EFB(s) may be supported through beam steering within the same satellite.

In the inter-SAT handover procedure, terminal(s) may perform handover procedure(s) between satellites. In the inter-SAT handover procedure, all terminals connected to a first cell of the first satellite may be handed over to a second cell of the second satellite. In this case, all terminals may be handed over to the second satellite at the same or similar time. The handover procedure performed during a period from the first time to the second time may be the inter-SAT handover procedure. EFB(s) may be supported through a new cell of a new satellite (e.g. the second satellite).

Due to the high altitude in the non-terrestrial network, handover procedures based on reference signal received power (RSRP) may not be efficient. Therefore, a handover procedure suitable for the non-terrestrial network may be needed. Even when a satellite in the EFB environment moves in the non-terrestrial network, a cell area on the ground may be maintained. In other words, the satellite may support a fixed cell area. The intra-SAT handover procedure and/or the inter-SAT handover procedure may be performed simultaneously for terminals (e.g. all terminals or some terminals) within the same cell. An efficient handover procedure considering the characteristics of the above-described EFB non-terrestrial network may be required.

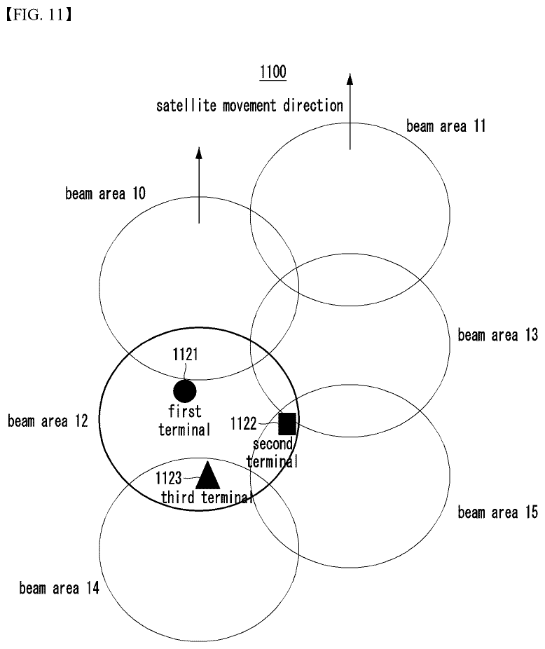

FIG. 11 is a conceptual diagram illustrating a third exemplary embodiment of a handover procedure.

As shown in FIG. 11, in an EMB environment, terminals included in the same beam area may have different remaining cell times depending on locations of the terminals. When the remaining cell times are different for the respective terminals, a time at which each terminal requests a handover may differ. For example, a first terminal 1121, a second terminal 1122, and a third terminal 1123 may be included in one beam area (e.g. beam area 12). The remaining cell time of the first terminal 1121 may be the longest compared to the other terminals. In this case, the terminals belonging to the same beam area may perform handovers in an order of ascending remaining cell time values.

Meanwhile, independently of the remaining cell times, a target satellite of a terminal may change depending on a location of the terminal. For example, the third terminal may be included in the beam area 12, but may also be included in a beam area 14. The second terminal may be included in beam areas 12, 13, and 15. Therefore, the third terminal may perform a handover procedure to a target satellite supporting the beam area 14. The second terminal may perform a handover procedure to a target satellite supporting the beam area 15.

The satellite may configure groups for terminals based on the remaining cell time values and beam area determination information, so that terminals within the same beam area can perform handover procedures through common signaling. The beam area determination information may refer to information for determining one beam area that supports a terminal when the terminal is included in a plurality of beam areas. The beam area determination information may include at least one of location information of the terminal, ephemeris information of the satellite, or an identifier (ID) of the target satellite. The location information of the terminal may include at least one of recent location information, past location information, movement seed or movement direction of the terminal. The movement speed and movement direction of the terminal may be determined based on recent location information and/or past location information of the terminal. The remaining cell time and/or the ID of the target satellite may be updated based on the location information of the terminal.

Meanwhile, according to the present disclosure, a beam area may be determined in an environment where a terrestrial network and a non-terrestrial network coexist. A method for determining a beam area in an environment where a terrestrial network and a non-terrestrial network coexist will be described later.

The satellite may transmit a location information request message to terminals to acquire the location information of the terminals. Additionally, the satellite may configure terminals through an RRC configuration message so that the terminals periodically transmit their location information to the satellite. In the present disclosure, only recent location information of the terminals may be used.

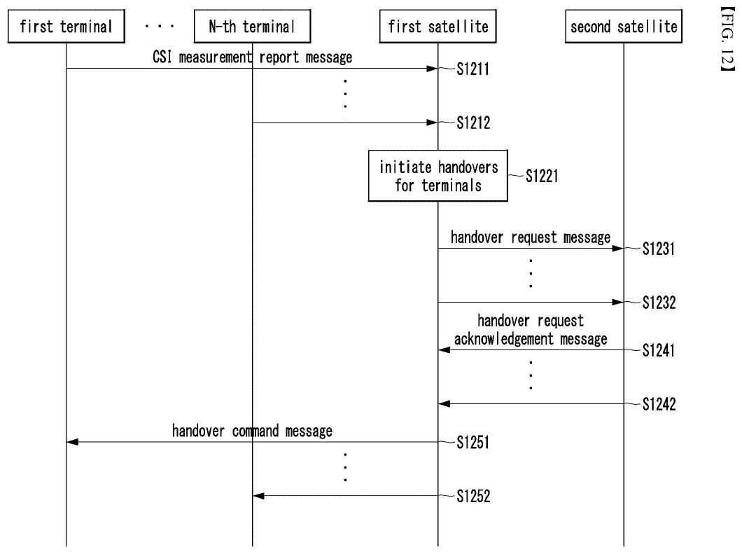

FIG. 12 is a sequence chart illustrating a first exemplary embodiment of a handover procedure.

As shown in FIG. 12, a handover procedure is illustrated. In FIG. 12, a satellite may refer to a base station. In other words, a first satellite may represent a first base station. Also, a second satellite may represent a second base station.

Terminals may measure channel state information (CSI) to perform handovers. A first terminal may transmit a CSI measurement report message to the first satellite (S1211). The CSI measurement report message may include CSI. The first satellite may receive the CSI measurement report message transmitted by the first terminal. An N-th terminal may transmit a CSI measurement report message to the first satellite (S1212). The first satellite may receive the CSI measurement report message transmitted by the N-th terminal.

The first satellite may initiate a handover for each terminal based on the CSI measurement report message of each terminal (S1221). The first satellite may transmit a handover request message for each terminal to the second satellite (S1231, S1232). The second satellite may receive the handover request messages transmitted by the first satellite. The second satellite may determine whether to approve a handover for each terminal based on the received handover request messages. When the second satellite approves the handover, the second satellite may transmit a handover request acknowledgment message for each terminal to the first satellite (S1241, S1242). The first satellite may receive the handover request acknowledgment messages transmitted by the second satellite. The first satellite may transmit a handover command message to the first terminal. The first terminal may receive the handover command message transmitted by the first satellite (S1251). The first satellite may transmit a handover command message to the N-th terminal. The N-th terminal may receive the handover command message transmitted by the first satellite (S1252). When the first terminal receives the handover command message transmitted by the first satellite, the first terminal may perform an access procedure to the second satellite. In other words, the first terminal may perform a random access to the second satellite (i.e. target satellite), and may transmit a handover complete message to the second satellite. When the N-th terminal receives the handover command message transmitted by the first satellite, the N-th terminal may perform an access procedure to the second satellite. In other words, the terminal may perform a random access to the second satellite (i.e. target satellite), and may transmit a handover complete message to the second satellite.

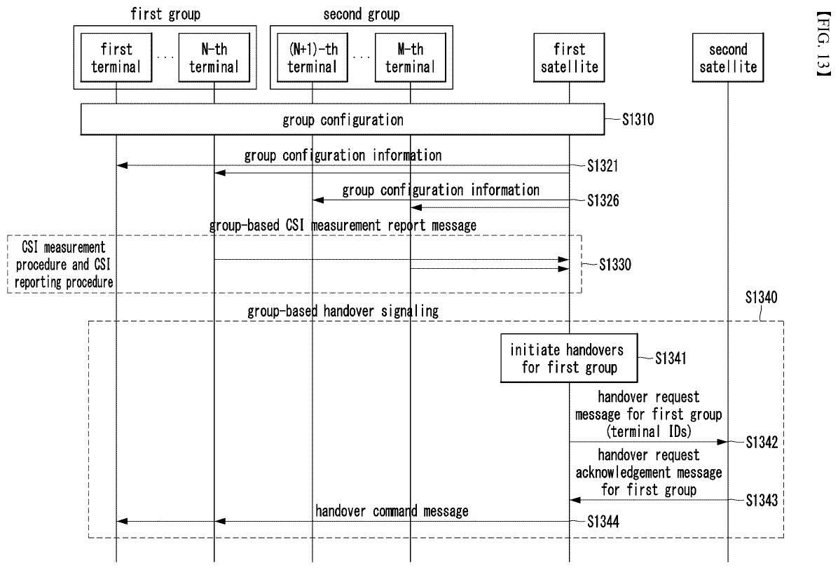

FIG. 13 is a sequence chart illustrating a second exemplary embodiment of a handover procedure.

As shown in FIG. 13, a procedure performed by the first satellite may be performed by the first base station. A procedure performed by the first satellite may be performed by the first satellite and the first base station. A procedure performed by the second satellite may be performed by the second base station. A procedure performed by the second satellite may be performed by the second satellite and the second base station. The first base station or the second base station may be a base station in a non-terrestrial network based on a transparent payload or a base station in a non-terrestrial network based on a regenerative payload. In the non-terrestrial network based on a transparent payload, the base station may be located on the ground. The handover procedure of the present disclosure may be performed in a non-terrestrial network based on a regenerative payload. The handover procedure of the present disclosure may be performed in a non-terrestrial network based on a transparent payload.

The first satellite may configure a group for terminals within a cell area or a beam area supported by the first satellite (S1310). The terminals in the cell area may refer to terminals included in at least one beam area. Therefore, the terminals within the cell area may be included in different beam areas supported by the first satellite. The first to N-th terminals may be included in a first beam area, and the first satellite may configure the first to N-th terminals included in the first beam area as a first group. The (N+1)-th to M-th terminals may be included in a second beam area, and the first satellite may configure the (N+1)-th to M-th terminals included in the second beam area as a second group.

The first satellite may configure at least one group for terminals within a beam area supported by the first satellite (S1310). For example, the first to N-th terminals may be included in the first beam area. The first satellite may configure the first to N-th terminals as the first group, and may configure the (N+1)-th to M-th terminals as the second group. In this case, the first satellite may transmit group configuration information to each terminal through RRC signaling. The group configuration information may include at least one of a group identifier (group ID), identifiers of terminals belonging to a group, or CSI configuration information (e.g. CSI measurement sequence for terminals measuring CSI, CSI measurement information, CSI reporting periodicity, and/or CSI reporting time). All terminals in the same group may apply a single common signaling.

When the first satellite configures a group for terminals, the terminals in the group may perform handover procedures. To perform the handover procedures, the terminals may perform a CSI measurement procedure and a CSI reporting procedure. In the present disclosure, only a part of the terminals belonging to the same group may perform the CSI measurement procedure and the CSI reporting procedure.

When there is one group for terminals, the first satellite may set the number of terminals that perform the CSI measurement procedure and the CSI reporting procedure within the group. The number of terminals that perform the CSI measurement procedure and the CSI reporting procedure in the group may be referred to as K. The number K of terminals that perform the CSI measurement procedure and the CSI reporting procedure may be determined through a terminal selection method of the satellite. The terminal selection method of the satellite may include a method of random selection and a method of selection based on values of remaining cell time.

The remaining cell times of the terminals included in the beam area may fall within a time range configured by the satellite. The number of terminals having remaining cell times falling within the time range configured by the satellite may be referred to as K.

When K is 1, it may mean that one terminal in the group performs the CSI measurement procedure and the CSI reporting procedure. Therefore, when K is 1, overhead caused by the handover procedures performed by the terminals in the group may be the lowest. In addition, the first satellite may set K to be at least 2 or more. The first satellite may configure all K terminals to perform the CSI measurement procedure and the CSI reporting procedure. The first satellite may also configure the K terminals to perform the CSI measurement procedure and the CSI reporting procedure sequentially in an order. For example, when the first satellite transmits a group indicator to the terminals, the first satellite may transmit at least one of a group identifier, flag indicating application of an order, CSI measurement periodicity, CSI reporting periodicity, CSI measurement times, or CSI reporting times to the terminals.

In addition, the first satellite may configure different reporting times for the respective terminals that perform the CSI measurement procedure and the CSI reporting procedure. The first satellite may configure a CSI measurement time and a CSI reporting time of each terminal through a modulo operation based on at least one of a cell-radio network temporary identifier (C-RNTI), a remaining cell time, a current time, or a system frame number (SFN) value.

Furthermore, the first satellite may change a CSI measurement periodicity and a CSI reporting periodicity based on a value of remaining cell time. For example, when the remaining cell time is small, the first satellite may set the CSI measurement periodicity and the CSI reporting periodicity to be short. In addition, when the remaining cell time is large, the first satellite may set the CSI measurement periodicity and the CSI reporting periodicity to be long.

When there are two or more groups for the terminals, the first satellite may set K for each group. In this case, the first satellite may set K differently for each group. By setting K differently for each group, the first satellite may control the number of terminals that perform the CSI measurement procedure and the CSI reporting procedure in the group for which the handover procedures are required.

Meanwhile, when the first satellite configures a group for terminals in a cell area or a beam area supported by the first satellite, the first satellite may determine a beam area for the terminals.

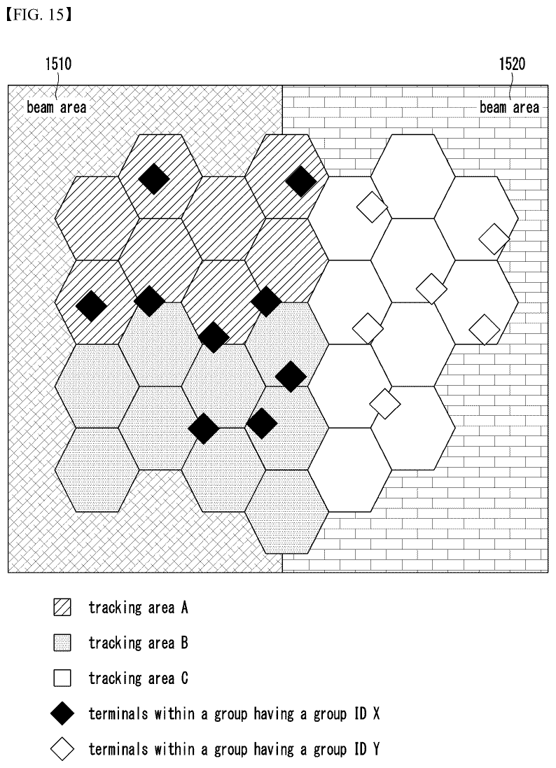

FIG. 15 is a conceptual diagram illustrating a first exemplary embodiment of a beam area determination method.

As shown in FIG. 15, a method for determining a beam area for a satellite when terminals belong to a terrestrial network area and a non-terrestrial network area is illustrated. FIG. 15 may represent grouping non-terrestrial network terminals based on tracking area information of the terrestrial network. According to the present disclosure, a beam area may be determined by considering a tracking area of each terminal when configuring a group for the terminals in an environment where the terrestrial network and the non-terrestrial network coexist. In other words, when configuring a group for the terminals, the present disclosure may first consider the tracking area of each terminal in the terrestrial network environment, and then configure the group. FIG. 15 illustrates two beam areas. The two beam areas may refer to a beam area 1510 and a beam area 1520.

A method for configuring groups for the terminals based on tracking areas may include a method for determining beam areas. The method for determining beam areas may consider the tracking areas. When considering a tracking area, the satellite may consider how much of a beam area is occupied by the tracking area. In other words, the satellite may consider how much each tracking area overlaps with each beam area. For example, since a tracking area A occupies a larger portion of a beam area X than beam area Y, the satellite may determine that terminals in the tracking area A belong to the beam area 1510. The satellite may transmit a group identifier X for the beam area 1510 to the terminals in the tracking area A. Since the tracking area C occupies a larger portion of the beam area Y than the beam area X, the satellite may determine that terminals in the tracking area C belong to the beam area 1520. The satellite may transmit a group identifier Y for the beam area 1520 to the terminals in the tracking area C.

The satellite may configure a group by transmitting the group identifier X to the terminals in the tracking area A and the tracking area B. The satellite may configure a group by transmitting a group identifier Y to the terminals in the tracking area C.

Meanwhile, referring again to FIG. 13, the first satellite may transmit group configuration information to each terminal (S1321). The group configuration information may include a group indicator. In other words, the first satellite may transmit group configuration information for the first group to each terminal (S1321). The first group may include the first to N-th terminals. In addition, the first satellite may transmit group configuration information for the second group to each terminal. The second group may include the (N+1)-th to M-th terminals.

When the first satellite transmits group configuration information to the terminal, the first satellite may transmit the group information through at least one of RRC signaling, system information, a medium access control (MAC) control element (CE), or downlink control information (DCI). The first satellite may select a signaling scheme based on a frequency of transmitting the group configuration information to the terminal. For example, when the first satellite frequently transmits group configuration information to the terminal, the first satellite may transmit the group configuration information through RRC signaling. When the first satellite does not frequently transmit group configuration information to the terminal, the first satellite may transmit the group configuration information through system information.

Meanwhile, when the first satellite transmits group configuration information to each terminal, the first satellite may transmit information on whether to perform a CSI measurement procedure and a CSI reporting procedure. For example, the first satellite may transmit information (or an indicator) instructing each terminal to perform the CSI measurement procedure and the CSI reporting procedure. Additionally, the first satellite may transmit information (or an indicator) instructing each terminal not to perform the CSI measurement procedure and the CSI reporting procedure. The first satellite may transmit information (or an indicator) instructing to perform the CSI measurement procedure and the CSI reporting procedure only to terminals that perform the CSI measurement procedure and the CSI reporting procedure. The first satellite may not transmit any information to terminals that do not perform the CSI measurement procedure and the CSI reporting procedure. Conversely, the first satellite may not transmit information (or an indicator) instructing to perform the CSI measurement procedure and the CSI reporting procedure to terminals that perform the CSI measurement procedure and the CSI reporting procedure. Additionally, the first satellite may transmit information (or an indicator) instructing not to perform a CSI measurement procedure and a CSI reporting procedure only to terminals that do not perform the CSI measurement procedure and the CSI reporting procedure.

All terminals in the same group may not perform the CSI measurement procedure and the CSI reporting procedure. Terminals that perform the CSI measurement procedure and the CSI reporting procedure in the first group and terminals that perform the CSI measurement procedure and the CSI reporting procedure in the second group may generate CSI. The terminals that perform the CSI measurement procedure and the CSI reporting procedure in the first group and the terminals that perform the CSI measurement procedure and the CSI reporting procedure in the second group may transmit a group-based CSI measurement report message to the first satellite (S1330). The CSI measurement report message may include CSI.

Meanwhile, due to the movement of the satellite, a group for terminals may be changed during the CSI measurement procedure and the CSI reporting procedure. A change in a group identifier of a terminal may be referred to as a group update. In this case, a terminal performing the CSI measurement procedure and the CSI reporting procedure may not follow the instruction for performing the CSI measurement procedure and the CSI reporting procedure that was transmitted prior to the group update. In other words, the terminal performing the CSI measurement procedure and the CSI reporting procedure may stop the CSI measurement procedure and the CSI reporting procedure. In addition, the terminal performing the CSI measurement procedure and the CSI reporting procedure may continue to perform the CSI measurement procedure and the CSI reporting procedure. A CSI measurement report message transmitted from a terminal whose group has been updated may be transmitted to the first satellite. The first satellite may not use the CSI measurement report message transmitted from the terminal whose group has been updated. Additionally, the first satellite may use the CSI measurement report message transmitted from the terminal whose group has been updated as CSI measurement information for a newly configured group.

The first satellite, the second satellite, and the terminals may perform a handover signaling procedure (S1340). In the handover, each terminal may perform the CSI measurement procedure, the CSI reporting procedure, and the handover signaling procedure individually. Therefore, the satellites may individually perform procedures such as receiving a CSI measurement report message, making a handover decision, transmitting a handover request message, transmitting a handover request acknowledgment message, or transmitting a handover command message for each terminal belonging to a cell in the non-terrestrial network environment. However, in the non-terrestrial network environment, the satellite may face a problem of having to handle a large number of handover procedures simultaneously. In this case, since the handover is performed due to the movement of the satellite, the terminals configured as the same group may perform the handover procedure through the same signaling.

The first satellite may perform a handover initiation procedure (S1341). In this case, the first satellite may determine a handover based on a group. In addition, when there are multiple groups, the first satellite may perform the handover initiation procedure for each group.

When a handover procedure is initiated for the first group, the first satellite may transmit a group-based handover request message for the first group to the second satellite (S1342). The handover request message may include IDs of the terminals in the first group and configuration information of the terminals. In this case, the configuration information of the terminals may include common configuration information and individual configuration information. The second satellite may receive the group-based handover request message for the first group transmitted by the first satellite.

The second satellite may transmit a group-based handover request acknowledgment message for the first group to the first satellite (S1343). The first satellite may receive the group-based handover request acknowledgment message for the first group transmitted by the second satellite.

The first satellite may transmit a handover command message to all terminals in the first group (S1344). In this case, the first satellite may transmit a group-based handover request acknowledgment message for the first group to each terminal in the first group. The first satellite may transmit the handover request acknowledgment message to each terminal in the first group through a unicast, groupcast, or broadcast scheme. The first satellite may transmit a handover command message to each terminal in the first group through a unicast, groupcast, or broadcast scheme. In this case, the first satellite may transmit information commonly transmitted to the terminals in the group through a unicast, groupcast, or broadcast scheme. The first satellite may transmit individual information for each terminal in the first group to each terminal in the first group through individual signaling. The handover command message may include a group handover indicator. The group handover indicator may represent whether the group-based handover is applied. Through the group handover indicator, each terminal in the first group may recognize whether a non-group-based handover or a group-based handover is applied. Each terminal in the first group may receive the handover command message transmitted by the first satellite.

Group-based signaling may be used when at least one of the handover request message, the handover request acknowledgment message, or the handover command message is transmitted. The group-based signaling may refer to using one common signaling within the group.

Upon receiving the handover command message transmitted by the first satellite, a terminal (e.g. a terminal belonging to the first group) may perform an access procedure to the second satellite. In other words, the terminal may perform a random access to the second satellite (i.e. target satellite), and the terminal may transmit a handover complete message to the second satellite.

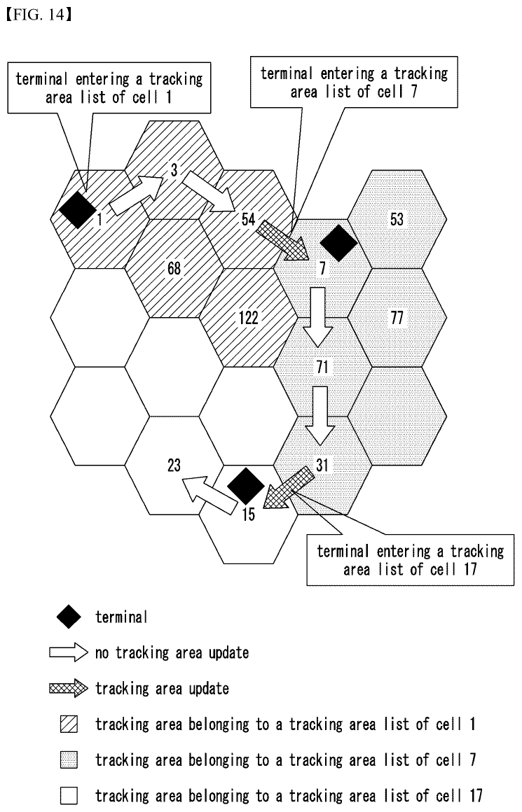

FIG. 14 is a conceptual diagram illustrating a first exemplary embodiment of tracking areas.

As shown in FIG. 14, a tracking area update will be described.

The present disclosure proposes a method of configuring groups in association with tracking areas of a terrestrial network in a case where the terrestrial network and the non-terrestrial network environment coexist. In the terrestrial network environment, each tracking area may be composed of a set of one or more adjacent cells. Each cell may belong to one tracking area.

FIG. 14 illustrates three tracking areas. A terminal may perform a tracking area update procedure at a time when a tracking area is changed. In FIG. 14, the terminal may perform the tracking area update twice.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner. The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a user equipment (UE), comprising:
receiving, from a satellite, group configuration information for a group including the UE based on a beam area supported by the satellite;
receiving, from the satellite, a group indicator indicating the group;
measuring channel state information (CSI) for the group;
reporting a message including the CSI to the satellite; and
receiving, from the satellite, a handover command message for a handover determined based on a result of measuring the CSI.

2. The method according to claim 1, wherein the group configuration information includes at least one group identifier (ID) based on the beam area.

3. The method according to claim 1, wherein when a cell remaining time, which is a time during which the UE is in a condition to be serviced by the beam area, falls within a time range configured by the satellite, the group configuration information includes a group ID for identifying the group including UEs having the cell remaining time.

4. The method according to claim 1, further comprising: determining the beam area that occupies a largest portion of a tracking area among beam areas supported by the satellite as a beam area associated with the tracking area.

5. The method according to claim 1, further comprising: determining the beam area supporting the UE based on beam area determination information including at least one of location information of the UE, ephemeris information of the satellite, or information of a target base station.

6. The method according to claim 1, further comprising: receiving, from the satellite, at least one of an indicator instructing to perform a CSI measurement processor and a CSI reporting procedure or an indicator instructing not to perform a CSI measurement procedure and a CSI reporting procedure.

7. The method according to claim 1, wherein the receiving of the handover command message from the satellite comprises: receiving, from the satellite, information that the satellite commonly transmits to the group through a unicast, groupcast, or broadcast scheme.

8. A method of a satellite, comprising:
configuring a group for user equipments (UEs) served by the satellite based on a beam area supported by the satellite;
transmitting a group indicator for the group to the UEs;
selecting, from among the UEs, at least one UE to perform a channel state information (CSI) measurement procedure and a CSI reporting procedure;
receiving a message including CSI for the group from the at least one UE;
transmitting a handover request message for a handover determined based on the CSI to a target satellite;
receiving a handover request acknowledgement message from the target satellite indicating that a handover request according to the handover request message has been approved; and
in response to the handover request of the satellite having been approved by the target satellite, transmitting a handover command message to the UEs belonging to the group.

9. The method according to claim 8, wherein the configuring of the group for UEs served by the satellite comprises: configuring the group for the UEs based on at least one of the beam area, cell remaining times which are times during which the UEs are in a condition to be serviced by the beam area, or beam area determination information, wherein the beam area determination information includes at least one of location information of the UEs, ephemeris information of the satellite, or information of the target satellite.

10. The method according to claim 8, wherein the selecting of the at least one UE to perform the CSI measurement procedure and the CSI reporting procedure comprises: selecting, from among the UEs, a UE having a cell remaining time falling within a time range configured by the satellite as the at least one UE to perform the CSI measurement procedure and the CSI reporting procedure, the cell remaining time being a time during which the UE is in a condition to be served by the beam area.

11. The method according to claim 8, wherein the transmitting of the handover command message to the UEs belonging to the group comprises: transmitting, to the UEs, information to be transmitted commonly to the group through a unicast, groupcast, or broadcast scheme.

12. A user equipment (UE) comprising at least one processor, wherein the at least one processor causes the UE to perform:
receiving, from a satellite, group configuration information for a group including the UE based on a beam area supported by the satellite;
receiving, from the satellite, a group indicator indicating the group;
measuring channel state information (CSI) for the group;
reporting a message including the CSI to the satellite; and
receiving, from the satellite, a handover command message for a handover determined based on a result of measuring the CSI.

13. The UE according to claim 12, wherein the group configuration information includes at least one group identifier (ID) based on the beam area.

14. The UE according to claim 12, wherein when a cell remaining time, which is a time during which the UE is in a condition to be serviced by the beam area, falls within a time range configured by the satellite, the group configuration information includes a group ID for identifying the group including UEs having the cell remaining time.

15. The UE according to claim 12, wherein the at least one processor causes the UE to perform: determining the beam area that occupies a largest portion of a tracking area among beam areas supported by the satellite as a beam area associated with the tracking area.

16. The UE according to claim 12, wherein the at least one processor causes the UE to perform: determining the beam area supporting the UE based on beam area determination information including at least one of location information of the UE, ephemeris information of the satellite, or information of a target base station.

17. The UE according to claim 12, wherein the at least one processor causes the UE to perform: receiving, from the satellite, at least one of an indicator instructing to perform a CSI measurement processor and a CSI reporting procedure or an indicator instructing not to perform a CSI measurement procedure and a CSI reporting procedure.

18. The UE according to claim 12, wherein in the receiving of the handover command message from the satellite, the at least one processor causes the UE to perform: receiving, from the satellite, information that the satellite commonly transmits to the group through a unicast, groupcast, or broadcast scheme.
